(19) United States
(12) Patent Application Publication
(10) Pub. No.: US 2015/0077575 A1
(43) Pub. Date: Mar. 19, 2015

(54) VIRTUAL CAMERA MODULE FOR HYBRID DEPTH VISION CONTROLS

(71) Applicant: Scott Krig, Santa Clara, CA (US)

(72) Inventor: Scott Krig, Santa Clara, CA (US)

(21) Appl. No.: 14/026,826

(22) Filed: Sep. 13, 2013

(51) Int. Cl. H04N 5/225; H04N 1/00

(52) U.S. Cl. CPC H04N 5/2257; H04N 1/00204; H04N 1/00347; H04N 2201/0075; H04N 2201/0084
USPC 348/207.11

(57) ABSTRACT

An apparatus, image capture device, and computing device are described herein. The apparatus includes logic to enumerate the image capture components of the apparatus. The apparatus also includes logic to define the capabilities of the image capture components of the apparatus. Additionally, the apparatus includes logic to communicate with the image capture components in a standardized fashion.

### TECHNICAL FIELD

The present techniques relate generally to a camera module. More specifically, the present techniques relate to a virtual camera module (VCM) with descriptive and protocol components.

### BACKGROUND ART

Computing platforms such as computing systems, tablets, laptops, mobile phones, and the like include various imaging hardware and software modules that are used to capture images. Further, the imaging hardware and software can be arranged in any number of configurations, dependent on the manufacturer of the platform.

### BRIEF DESCRIPTION OF THE DRAWINGS

FIG. 1 is a block diagram of a computing device that may include a virtual camera module;

FIG. 2 is an example of a virtual camera module (VCM) with an image capture mechanism;

FIG. 3A is an illustration of a sequence of depth images;

FIG. 3B is an illustration of depth image lines;

FIG. 4 is an illustration set of depth images associated with a variety of formats;

FIG. 5 is a process flow diagram of a method to enable a virtual camera module;

FIG. 6 is a block diagram of an exemplary system for enabling a VCM; and

FIG. 7 is a schematic of a small form factor device in which the system 600 of FIG. 6 may be embodied.

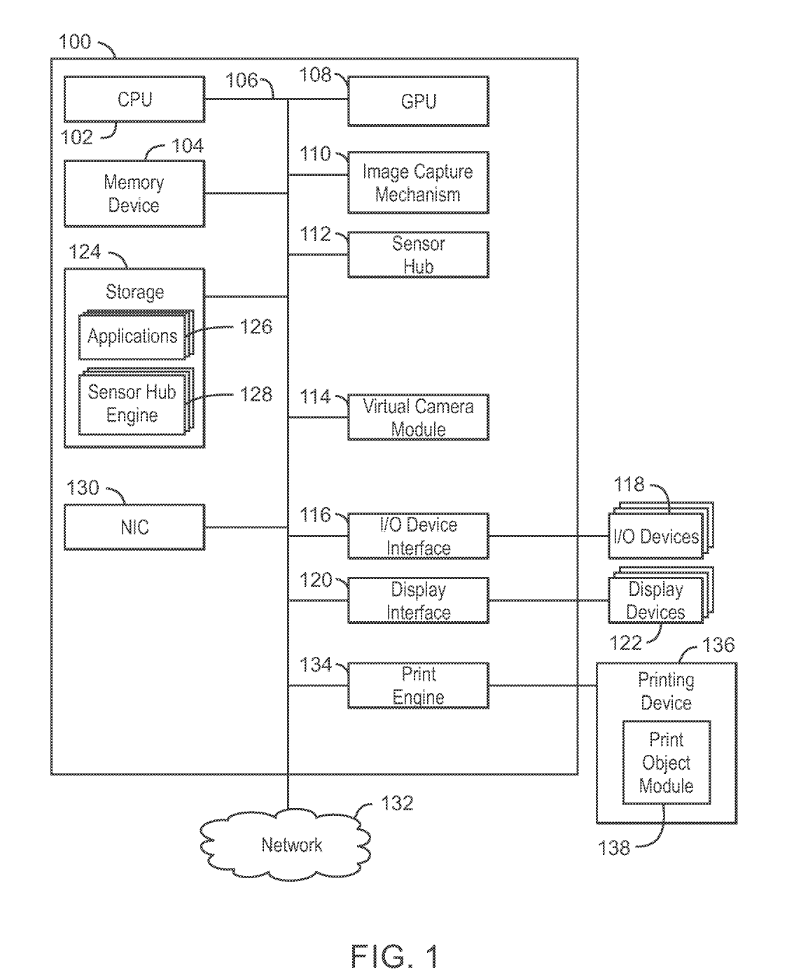

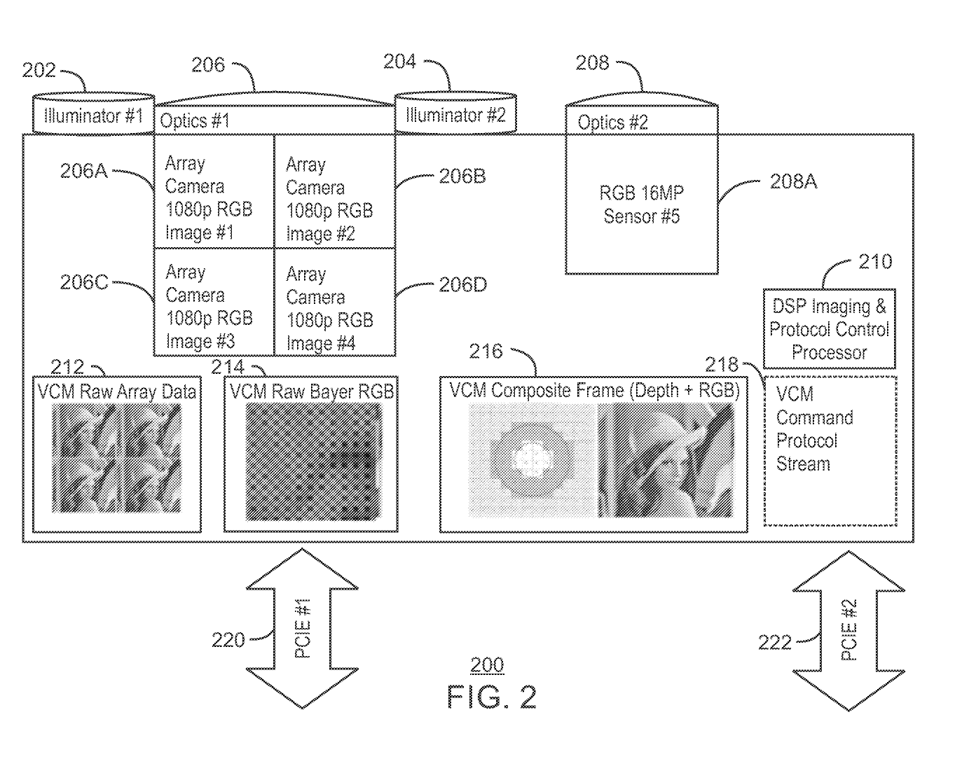

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Imaging hardware and software can be arranged in any number of configurations, dependent on the manufacturer of a computing platform. Various depth sensors and two dimensional (2D) imaging sensors have emerged in a wide range of camera modules, each module composed of different sensor configurations, controls, and formats for 2D/3D data. For example, a depth camera module may include a stereo camera working using two imaging sensors for left & right images with an eight megapixel red green blue (RGB) sensor combined together into a single camera. Another depth camera module may include time-of-flight sensor working with a single RGB sensor combined into a single cameras. Another camera module may provide a combination of capabilities and sensors together such as computer vision capabilities, image processing capabilities, depth sensing capabilities such as from a stereo camera, visible or Infra Red illuminators, accelerometer, compass, GPS unit, and an RGB image sensor all together in the camera module. The present techniques cover various combinations and embodiments of sensors in the same camera module.

Embodiments described herein provide a Virtual Camera Module (VCM). The VCM may be a hybrid camera module that is a component of a computing platform. The VCM enables different configurations of three dimensional (3D) depth vision systems and 2D imaging camera systems to be designed easily, be interchangeable, and be controllable and extensible.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may include a virtual camera module (VCM). The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to implement shared virtual memory. The memory device 104 can include random access memory (RAM), read only memory (ROM), flash memory, or any other suitable memory systems. For example, the memory device 104 may include dynamic random access memory (DRAM).

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines (not shown), wherein each graphics engine is configured to perform specific graphics tasks, or to execute specific types of workloads. For example, the GPU 108 may include an engine that produces variable resolution depth maps. The particular resolution of the depth map may be based on an application.

The computing device 100 includes an image capture device 110. In embodiments, the image capture device 110 is a camera, stereoscopic camera, infrared sensor, or the like. The image capture device 110 is used to capture image information. The computing device 100 may also include a sensor hub 112. The sensor hub 112 may include various sensors, such as a depth sensor, an image sensor, an infrared sensor, an X-Ray photon counting sensor or any combination thereof. A depth sensor of the sensor hub 112 may be used to capture the depth information associated with the image information captured by an image sensor of the sensor hub 112. In some embodiments, the sensor hub 112 is a component of the image capture mechanism 110. Additionally, in embodiments, the sensor hub 112 provides sensor data to the image capture mechanism. The sensors of the sensor hub 112 may include image sensors such as charge-coupled device (CCD) image sensors, complementary metal-oxide-semiconductor (CMOS) image sensors, system on chip (SOC) image sensors, image sensors with photosensitive thin film transistors, or any combination thereof. In some embodiments, the sensor hub 112 may be an Embedded Services Hub or may be implemented within an Embedded Services Hub.

In embodiments, a depth sensor may produce a variable resolution depth map by analyzing variations between the pixels and capturing the pixels according to a desired resolution. Other types of sensors may be used in an embodiment such as accelerometers, GPS units, temperature gauges, altimeters, or other sensors as would be useful to one skilled in the art to solve a particular problem.

The computing device 100 also includes a VCM 114. The VCM 114 provides both descriptive and protocol methods for designers to reveal the capabilities of a camera module, such as the image capture mechanism 110. The VCM may also reveal or describe the sensors and features of the image capture mechanism 110. In this manner, the VCM enables the camera module capabilities to be defined, described and communicated in a standardized fashion. In embodiments, the VCM results in a faster time to market for computing platforms as well as lower cost solutions for imaging interfaces. Additionally, the VCM provides the common descriptive format for all features and capabilities of a virtual camera module, allowing camera module vendors and platform integrators to communicate key details of features and protocol via a standardized description of features, capabilities and protocol details. The VCM enables standardization and innovation, as the techniques are descriptive and enables new features and protocol capabilities to be added into the VCM description. Furthermore, in some embodiments, the VCM may be implemented using extensible markup language (XML). Additionally, in an embodiment, the VCM description may be written using the XML description language, or in another embodiment the VCM description may be written using ASCII text or BINARY information. Additionally, the common 2D and 3D imaging module controls and data formats provided by the VCM may result in a cohesive ecosystem for combined 2D/3D image sensor module vendors to support. The CPU 102 may be connected through the bus 106 to an input/output (I/O) device interface 116 configured to connect the computing device 100 to one or more I/O devices 118. The I/O devices 118 may include, for example, a keyboard and a pointing device, wherein the pointing device may include a touchpad or a touchscreen, among others. The I/O devices 118 may be built-in components of the computing device 100, or may be devices that are externally connected to the computing device 100.

The CPU 102 may also be linked through the bus 106 to a display interface 120 configured to connect the computing device 100 to a display device 122. The display device 122 may include a display screen that is a built-in component of the computing device 100. The display device 122 may also include a computer monitor, television, or projector, among others, that is externally connected to the computing device 100.

The computing device also includes a storage device 124. The storage device 124 is a physical memory such as a hard drive, an optical drive, a thumbdrive, an array of drives, or any combinations thereof. The storage device 124 may also include remote storage drives. The storage device 124 includes any number of applications 126 that are configured to run on the computing device 100. The applications 126 may be used to combine the media and graphics, including 3D stereo camera images and 3D graphics for stereo displays. In examples, an application 126 may be used to generate a variable resolution depth map.

The storage device 124 may also include a sensor hub engine 128. In some cases, a sensor hub engine includes software that enables the functionality of sensors of the sensor hub 112 within the computing device 100.

The computing device 100 may also include a network interface controller (NIC) 128 may be configured to connect the computing device 100 through the bus 106 to a network 132. The network 132 may be a wide area network (WAN), local area network (LAN), or the Internet, among others. In some embodiments, the VCM can send a captured image from to a print engine 134. The print engine 134 can send the resulting image to a printing device 136. The printing device 136 can include printers, fax machines, and other printing devices that can print the resulting image using a print object module 138. In embodiments, the print engine 134 may send data to the printing device 136 across the network 132.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

The VCM provides for both real components and virtual components. For example, a real component may be an individual 2D image sensor. In examples, a virtual component may be a feature such as a depth map cleanup method for noise reduction, a specific algorithm for depth map disparity calculations, or a composite frame combining a 2D sensor together with a corresponding depth map as shown in FIG. 2. In this manner, the VCM may be a hybrid camera module that combines both real and virtual components.

In embodiments, a VCM module may not have a physical accelerometer on board. In such a scenario, the VCM device driver software can make an accelerometer of the device appear to be a part of the VCM to a software developer, thus the VCM makes each camera module appear to be what is expected. Additionally, the software may be written to expect a VCM to provide a set of features including processing or depth capabilities, and the VCM itself may add functionality into the device driver so a software developer can rely on a VCM platform on top of which standardized applications can be written that expect a set of features. In this manner, the VCM abstracts and virtualizes the camera module into a combined set of features and functions that are expected, to enable software applications to be created on top of the VCM in a standardized, portable and predictable manner, easing software developer burden and increasing VCM device compatibility. In other words, the VCM provides a virtual device, and camera module vendors are able to provide more or less features than are expected. Further, a platform system integrator can add or subtract features from the device driver for presentation to the software developer.

FIG. 2 is an example of a VCM 200 with an image capture mechanism. The image capture mechanism may include an illuminator 202 and an illuminator 204, an optics component 206 and an optics component 208, and a Digital Signal Processing (DSP) Imaging and Protocol Control Processor 210. The illuminator 202 and the illuminator 204 may be any component used to alter the lighting during image capture. The optics component 206 and the optics component 208 may be any component used to capture the image or depth data. For example, the optics component may sense image or depth data through a monocular multi-view stereoscopic sensor, a stereoscopic camera sensor, a structured light sensor, an array camera, plenoptics, and the like. The optics sensor component 206 is illustrated as an array camera that captures four images 206A-D in an RGB format at 1080 pixels, and can generate 3D depth information. The optics sensor component 208 is illustrated as a 16 megapixel RGB sensor 208A.

Through the illuminator 202, the illuminator 204, the optics component 206, the optics component 208, and the DSP Imaging and Protocol Control Processor 210, the VCM 200 can produce a number of image formats. A VCM raw data array 212 may be produced that includes raw data from an array camera, such as the optics component 206. As shown, four images are produced by the optics component 206, however, and number of images may be produced by the optics component 206. The VCM may also produce VCM Raw Bayer RGB data 214. The VCM Raw Bayer RGB data 214 includes data that is not converted to pixels. Instead, the VCM Raw Bayer RGB data 214 is raw sensor data that may be exported from the VCM 200.

The VCM 200 may also produce a composite frame 216. The composite frame includes a depth map and corresponding image or texture. The depth map and corresponding RGB image may be associated together and transmitted together as a single composite frame. In embodiments, a composite frame could include raw Bayer format RGB and YUV format data as pixels.

In embodiments, the composite frame may be composed of real component data associated together into a set of time-stamped and corresponding images and sensor data to be transmitted together as a single frame. In an embodiment, a composite frame may contain a depth image set, an RGB image, and other sensor data such as an accelerometer or light meter reading combined together into a packet with a common timestamp so the sensor information may be associated together. Such a composite frame may be a preferred format in applications where the depth map is used together with the RGB texture which is then applied over the depth map, and then rendered by the GPU. Additionally, in applications such as computational photography, the raw Bayer format data may be preferred in order to enable photo editing software to apply ‘secret sauce’ algorithms to decode and synthesize the raw Bayer data into optimized RGB pixels. The VCM 200 provides methods to support these various data access formats and access patterns by enabling a camera module designer to define the VCM capabilities in a manner amenable to target applications, and also change the VCM schema to allow for enhancements in the future to reveal new capabilities while preserving legacy definitions.

A VCM command protocol stream 218 enables the VCM 200 to communicate the VCM configurations, methods, and protocols to other components of a computing system. For example, VCM 200 may communicate with other components using a PCIE1 220 for image data transfer, and a PCIE2 222 for protocol command and control.

The VCM does not proscribe the capability of the camera. Rather, the VCM enables the framework for the camera to be defined. Additionally, the VCM allows capabilities to be revealed during a protocol discovery process, where features can be accessed via the VCM protocol. A camera vendor can describe their camera capabilities in a standard VCM format, enabling discovery of VCM capabilities, protocol methods to control the parameters of the VCM, protocol methods to retrieve image frames from VCM. Moreover, each of the commands may be in a format such as [name], [parameter1], . . . , [parameter], where parameters may be items such as the name of a feature and the parameters available to control each of the features.

For example, sensor component definitions may be included with the virtual camera module. The sensor component definitions may include camera name and other camera identification, vendor specific hardware information, and the type of camera, such as monocular, RGB, depth, array, plenoptic, and the like. The sensor component definitions may also include power management controls, sensor wells (x size, y size, z bit depth, BAYER or other format), sensor line readout rate (minimum, type, maximum), sensor frame readout rate (minimum, type, maximum), the line scan mode line sizes supported, the frame Scan Mode Frame Sizes supported, variable frame/line size controls, variable frame rate controls, variable resolution 3D depth map format controls (bit depth, granularity), variable resolution 2D image controls (bit depth, granularity), and MEMS controls. A sensor commands list may also be provided. The sensor commands list may include commands such as Get Image Frame, Set Composite Frame Format, Get Composite Frame, Set Variable Resolution Depth map Format, Set Compression Format, Set Frame Size, Set Frame Rate, Set Depth Cleanup Algorithm, and Set Depth Map Algorithm.

Illuminator components may also be defined. The illuminator component definitions may include the illuminator name and other illuminator identification information, vendor specific hardware information, power management controls, the type of illuminator, power management controls, MEMS controls, and a list of supported illuminator commands. Similarly, optics components may be defined. The optics component definitions may include the optics component name and other optics component identification information, vendor specific hardware information, power management controls, the type of optics component, power management controls, MEMS controls, and a list of supported optics component commands.

The interface with the VCM may use any standardized interface presently developed or developed in the future. Such interfaces include support for MIPI, USB, PCIE, Thunderbolt, and Wireless interfaces. Additionally, the camera module definition may be defined by a set of all component definitions within the camera module, such as sensor, optics, illuminators, and other interfaces. The camera module definition may also include an association of components into a virtual camera, where the virtual camera includes a camera sensor list, a camera illuminator list, camera optics list, camera interface list. In some embodiments, the camera module definition may override frame rate, resolution, power management, and other setting previously set.

A composite frame, as discussed above, may also be defined by the VCM protocol. The composite frame definition may include the associated set of 3D/2D frames, the sensor component list, an identification for each frame, and a timestamp. Depth information, as associated with a composite frame, may be provided as a sequence of depth images, with each depth image using variable bit depths, variable spatial resolution, or any combination thereof with each frame in order to vary the depth resolution of each composite frame. Each depth image may be a point cloud, a depth map, or a three dimensional (3D) polygonal mesh that may be used to indicate the depth of 3D objects within the image.

Table 1 illustrates an exemplary set of commands for the sensor component definition, illuminator component definition, and the optics component definition when the VCM is implemented using XML. However, the VCM may be implemented using XML, flat ASCII files, binary encoded files, and the like.

TABLE 1

| Sensor Component | | |
|---|---|---|
| Definition (individual 2D/3D | Illuminator Component | Optics Component |
| sensors) | Definition | Definition |
| Camera Name | Illuminator Name | Optics Name |
| Camera ID | Illuminator ID | Optics ID |
| Vendor specific HW info | Vendor specific HW info | Vendor specific HW info |
| Type (MONO, RGB, DEPTH, | Power management controls | Power management controls |
| ARRAY, PLENOPTIC, | | |
| OTHER) | | |
| Power management controls | Type of illuminator | Type of optics |
| Sensor Wells (x size, y size, | Power management controls | Power management controls |
| z bit depth, BAYER or other | | |
| format) | | |
| Sensor line readout rate | MEMS controls | MEMS controls |
| (min, typ, max) | | |
| Sensor frame readout rate | Command list (list of | Command list (list of |
| (min, typ, max) | supported illuminator | supported illuminator |
| | commands) | commands) |
| Line Scan Mode Line Sizes | | |
| supported | | |
| Frame Scan Mode Frame | | |
| Sizes supported | | |
| Variable Frame/line Size | | |
| Controls | | |
| Variable Frame Rate | | |
| Controls | | |
| Variable Resolution 3D depth | | |
| map format controls (bit | | |
| depth, granularity) | | |
| Variable Resolution 2D | | |
| image controls (bit depth, | | |
| granularity) | | |
| MEMS controls | | |

Similarly, Table 2 illustrates an exemplary set of commands for the interface component definition, camera module definition, and the composite frame definition when the VCM is implemented using XML. As noted above, XML is used as an example and the VCM can be implemented using any language or format.

TABLE 2

| Interface | | Composite Frame |
|---|---|---|
| Component | | Definition (associated set |
| Definitions | Camera Module Definition | of 3D/2D frames) |
| MIPI | Set of all Component | See FIG. 2, VCM Composite |
| | Definitions (Sensor, Optics, | Frame |
| | Illuminators, Interfaces) | |
| UCB | Virtual Camera (association | Sensor Component list (see |
| | of components into a virtual | definition parameters above) |
| | camera) | |
| PCIE | Camera Sensor List | ID |
| Thunderbolt | Camera Illuminator List | Timestamp |
| Wireless | Camera Optics List | |
| | Camera Interface list | |
| | *Overrides for frame rate, | |
| | resolution, power | |
| | management, anything else | |

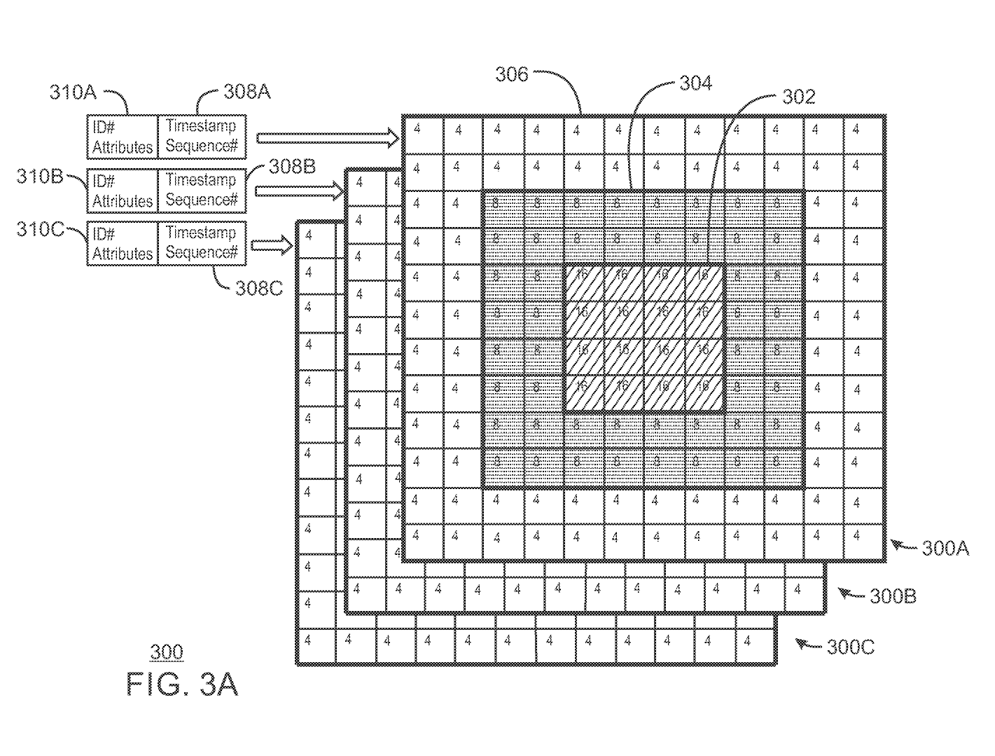

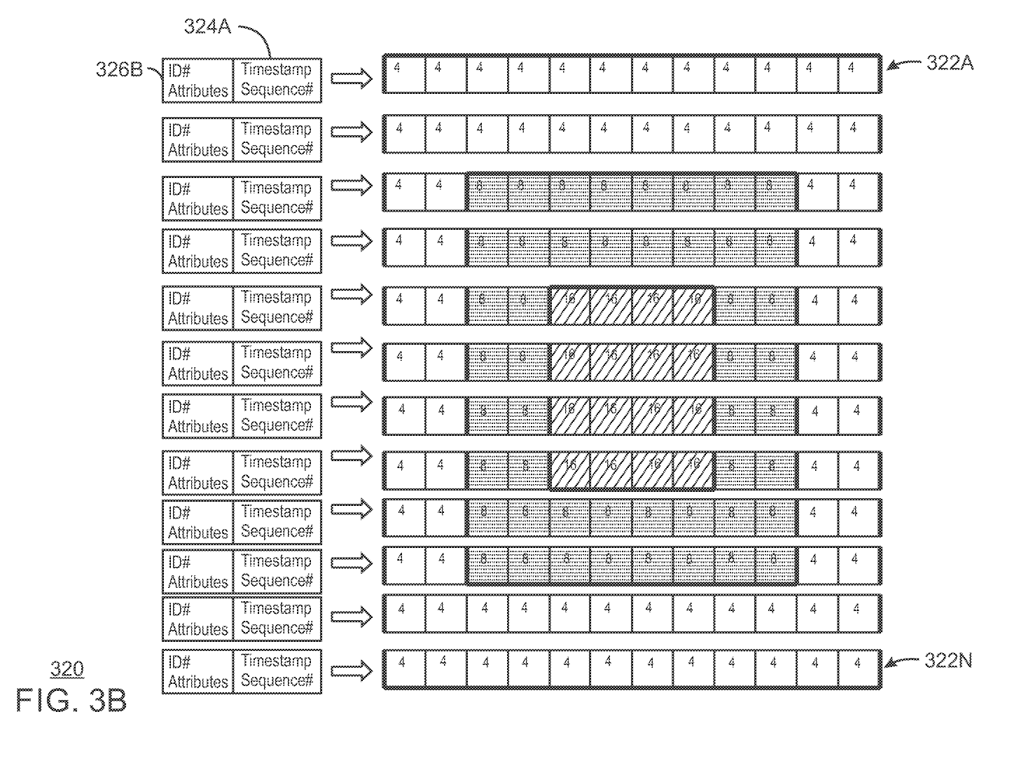

FIG. 3A is an illustration of a sequence of depth images 300. The depth images 300 may each be associated with a composite frame. The three depth images 300A, 300B, and 300C each include variable depth representations using variable bit depths, as illustrated. The depth images 300 vary the resolution by altering the number of bits used to store depth information different regions of the depth image. For example, the region 302 uses 16 bits to store depth information, the region 304 uses 8 bits to store depth information, and the region 306 uses 4 bits to store depth information. Thus, region 302 stores more depth information than region 304 and 306 and is the most descriptive of the depth in the image 300. Similarly, region 304 stores more depth information and is more descriptive of depth when compared to region 306. The region 306 stores the least amount of depth information and is the least descriptive of depth in the depth image 300. Although variable depth is described using variable bit depths in a depth image, any variable depth representation technique may be used, such as variable spatial resolution.

Each of the depth images 300A, 300B, and 300C has a corresponding timestamp 308 and identification number/attributes 310. Accordingly, the depth image 300A corresponds to a timestamp 308A and an identification number/attributes 310A, the depth image 300B corresponds to a timestamp 308B and a identification number/attributes 310B, and the depth image 300C corresponds to a timestamp 308C and a identification number/attributes 310C. The timestamps 308A, 308B, and 308C enable the depth images 300A, 300B, and 300C to be placed in the proper time sequence. The identification number/attributes 310A, 310B, and 310C are used to provide identifying information for their respective depth image.

FIG. 3B is an illustration of depth image lines 322A-322N. The depth image lines may each correspond to a timestamp 324 and an identification number/attributes 326. In this manner, each line of the depth image may also use a timestamp for sequencing.

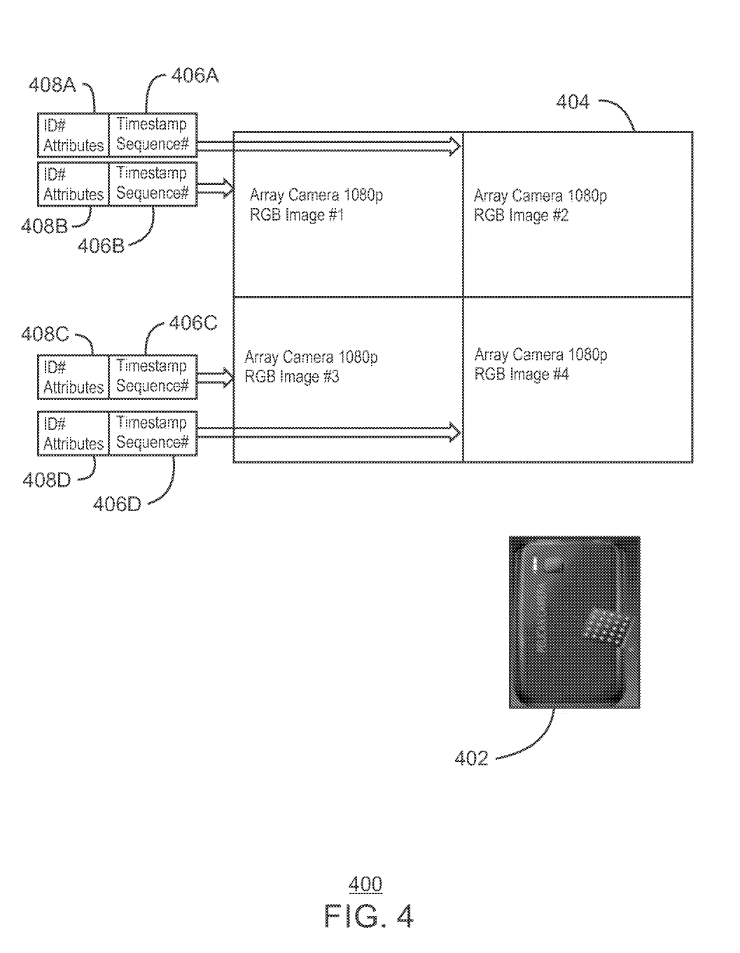

FIG. 4 is an illustration 400 set of depth images associated with a variety of formats. An array camera 402 may include a 5×5 sensor array that is used to produce an image with each sensor of the sensor array. Any size sensor array can be used. For example, the resulting set of depth images 404 were obtained from a 2×2 sensor array. Each image of the depth image set 404 includes a timestamp 406 and an identification number/attributes 408. Depending on the method used to capture the depth image, the each depth image may be a set of raw depth information from an array camera or a stereo camera. Each depth image may also be the computed depth image from the raw depth information, or each depth image may be RGB 2D image data. Each of the depth images may be associated in a set using the timestamp and the identification number/attributes.

In addition to depth and texture information, the composite frame may include a depth stream header and a depth image protocol. A depth image protocol may control the setup and transmission of the depth image information associated with the composite frame in a time sequence. A depth stream header may be used to describe the depth data stream. The depth stream header may include a compression format, the pixel data formats and structure of the pixel data, pixel depths, the pixel color space, camera configuration, camera number, type of image sensors, and camera vendor info. The depth image protocol may also include a set of raw depth information from an array camera or stereo cameras or other depth sensors, the computed depth images from the raw depth information, and RGB 2D image data.

As the time sequence of depth images is generated, the depth sensors of an image capture device can operate together with, for example, 2D color and gray scale image sensors. The depth information and the 2D color and gray scale information is associated together in a composite from such that the 2D color or gray scale image has a corresponding set of depth information in the form of a depth map, 3D point cloud, or 3D mesh representation. Alternatively, the depth sensing method may generate a time sequence of lines of depth information, where a line is a single line from a 2D image, where the line is considered to be the smallest frame or simply a degenerate case of a 2D frame as shown in FIG. 3B. Using the lines as illustrated in FIG. 3B, a depth image can be reconstructed from a set of lines given that each line has a time sequence number. Accordingly, the depth information may be contained in a time-sequence of depth images corresponding to a time-sequence of 2D color or gray scale image frames, or a set of time-sequenced lines of the image may be represented using the variable depth representations described above.

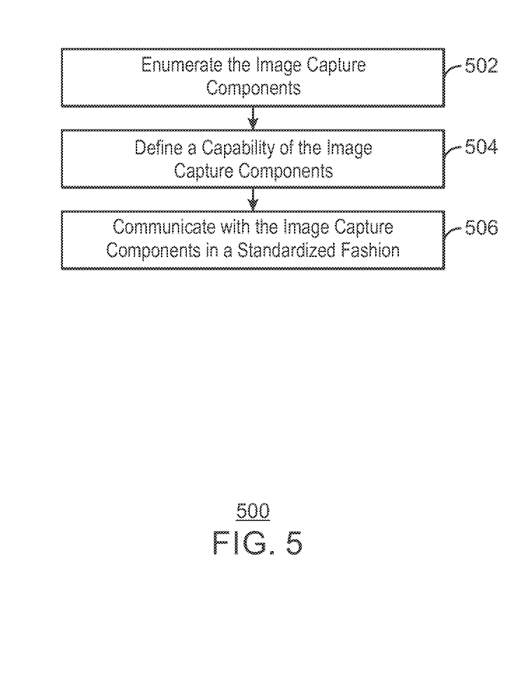

FIG. 5 is a process flow diagram of a method to enable a virtual camera module. At block 502, the image capture components are enumerated. In this manner, configurations of three dimensional (3D) depth vision systems and 2D imaging camera systems may be detected. At block 504, the capabilities of the image capture components are defined. At block 506, the image capture components may be communicated with in a standardized fashion.

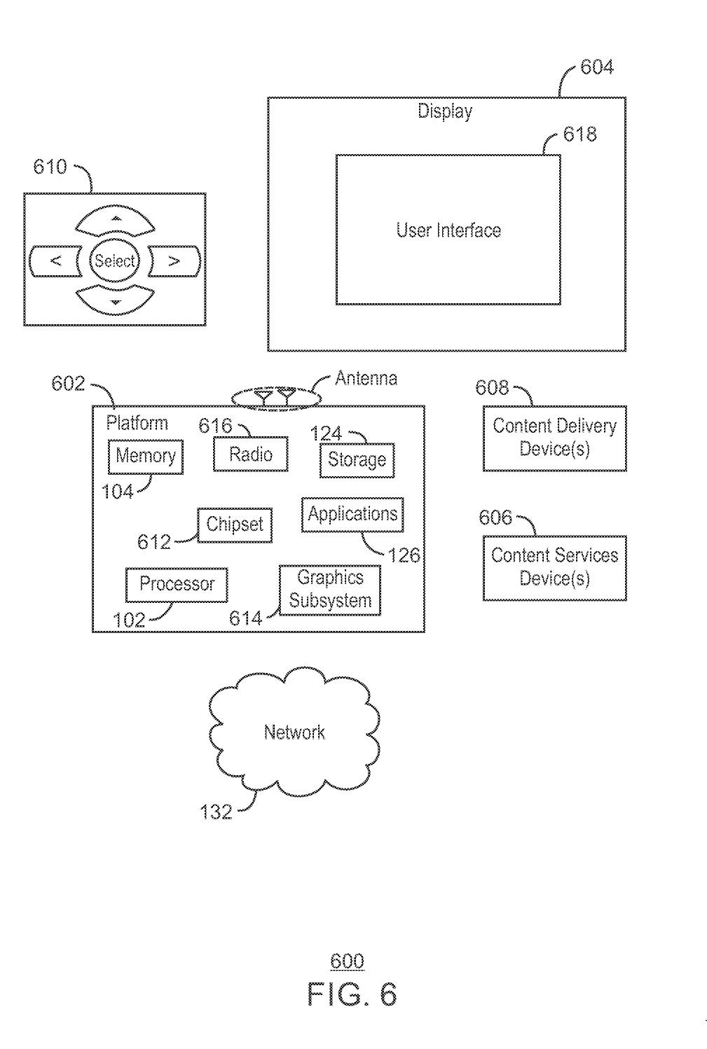

FIG. 6 is a block diagram of an exemplary system 600 for enabling a VCM. Like numbered items are as described with respect to FIG. 1. In some embodiments, the system 600 is a media system. In addition, the system 600 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, or the like.

In various embodiments, the system 600 comprises a platform 602 coupled to a display 604. The platform 602 may receive content from a content device, such as content services device(s) 606 or content delivery device(s) 608, or other similar content sources. A navigation controller 610 including one or more navigation features may be used to interact with, for example, the platform 602 and/or the display 604. Each of these components is described in more detail below.

The platform 602 may include any combination of a chipset 612, a central processing unit (CPU) 102, a memory device 104, a storage device 124, a graphics subsystem 614, applications 126, and a radio 616. The chipset 612 may provide intercommunication among the CPU 102, the memory device 104, the storage device 124, the graphics subsystem 614, the applications 126, and the radio 614. For example, the chipset 612 may include a storage adapter (not shown) capable of providing intercommunication with the storage device 124.

The CPU 102 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, the CPU 102 includes dual-core processor(s), dual-core mobile processor(s), or the like.

The memory device 104 may be implemented as a volatile memory device such as, but not limited to, a Random Access Memory (RAM), Dynamic Random Access Memory (DRAM), or Static RAM (SRAM). The storage device 124 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In some embodiments, the storage device 124 includes technology to increase the storage performance enhanced protection for valuable digital media when multiple hard drives are included, for example.

The graphics subsystem 614 may perform processing of images such as still or video for display. The graphics subsystem 614 may include a graphics processing unit (GPU), such as the GPU 108, or a visual processing unit (VPU), for example. An analog or digital interface may be used to communicatively couple the graphics subsystem 614 and the display 604. For example, the interface may be any of a High-Definition Multimedia Interface, DisplayPort, wireless HDMI, and/or wireless HD compliant techniques. The graphics subsystem 614 may be integrated into the CPU 102 or the chipset 612. Alternatively, the graphics subsystem 614 may be a stand-alone card communicatively coupled to the chipset 612.

The graphics and/or video processing techniques described herein may be implemented in various hardware architectures. For example, graphics and/or video functionality may be integrated within the chipset 612. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 616 may include one or more radios capable of transmitting and receiving signals using various suitable wireless communications techniques. Such techniques may involve communications across one or more wireless networks. Exemplary wireless networks include wireless local area networks (WLANs), wireless personal area networks (WPANs), wireless metropolitan area network (WMANs), cellular networks, satellite networks, or the like. In communicating across such networks, the radio 616 may operate in accordance with one or more applicable standards in any version.

The display 604 may include any television type monitor or display. For example, the display 604 may include a computer display screen, touch screen display, video monitor, television, or the like. The display 604 may be digital and/or analog. In some embodiments, the display 604 is a holographic display. Also, the display 604 may be a transparent surface that may receive a visual projection. Such projections may convey various forms of information, images, objects, or the like. For example, such projections may be a visual overlay for a mobile augmented reality (MAR) application. Under the control of one or more applications 126, the platform 602 may display a user interface 618 on the display 604.

The content services device(s) 606 may be hosted by any national, international, or independent service and, thus, may be accessible to the platform 602 via the Internet, for example. The content services device(s) 606 may be coupled to the platform 602 and/or to the display 604. The platform 602 and/or the content services device(s) 606 may be coupled to a network 132 to communicate (e.g., send and/or receive) media information to and from the network 132. The content delivery device(s) 608 also may be coupled to the platform 602 and/or to the display 604.

The content services device(s) 606 may include a cable television box, personal computer, network, telephone, or Internet-enabled device capable of delivering digital information. In addition, the content services device(s) 606 may include any other similar devices capable of unidirectionally or bidirectionally communicating content between content providers and the platform 602 or the display 604, via the network 132 or directly. It will be appreciated that the content may be communicated unidirectionally and/or bidirectionally to and from any one of the components in the system 600 and a content provider via the network 132. Examples of content may include any media information including, for example, video, music, medical and gaming information, and so forth.

The content services device(s) 606 may receive content such as cable television programming including media information, digital information, or other content. Examples of content providers may include any cable or satellite television or radio or Internet content providers, among others.

In some embodiments, the platform 602 receives control signals from the navigation controller 610, which includes one or more navigation features. The navigation features of the navigation controller 610 may be used to interact with the user interface 618, for example. The navigation controller 610 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures. Physical gestures include but are not limited to facial expressions, facial movements, movement of various limbs, body movements, body language or any combination thereof. Such physical gestures can be recognized and translated into commands or instructions.

Movements of the navigation features of the navigation controller 610 may be echoed on the display 604 by movements of a pointer, cursor, focus ring, or other visual indicators displayed on the display 604. For example, under the control of the applications 126, the navigation features located on the navigation controller 610 may be mapped to virtual navigation features displayed on the user interface 618. In some embodiments, the navigation controller 610 may not be a separate component but, rather, may be integrated into the platform 602 and/or the display 604.

The system 600 may include drivers (not shown) that include technology to enable users to instantly turn on and off the platform 602 with the touch of a button after initial boot-up, when enabled, for example. Program logic may allow the platform 602 to stream content to media adaptors or other content services device(s) 606 or content delivery device(s) 608 when the platform is turned “off.” In addition, the chipset 612 may include hardware and/or software support for 5.1 surround sound audio and/or high definition 7.1 surround sound audio, for example. The drivers may include a graphics driver for integrated graphics platforms. In some embodiments, the graphics driver includes a peripheral component interconnect express (PCIe) graphics card.

In various embodiments, any one or more of the components shown in the system 600 may be integrated. For example, the platform 602 and the content services device(s) 606 may be integrated; the platform 602 and the content delivery device(s) 608 may be integrated; or the platform 602, the content services device(s) 606, and the content delivery device(s) 608 may be integrated. In some embodiments, the platform 602 and the display 604 are an integrated unit. The display 604 and the content service device(s) 606 may be integrated, or the display 604 and the content delivery device(s) 608 may be integrated, for example.

The system 600 may be implemented as a wireless system or a wired system. When implemented as a wireless system, the system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum. When implemented as a wired system, the system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, or the like. Examples of wired communications media may include a wire, cable, metal leads, printed circuit board (PCB), backplane, switch fabric, semiconductor material, twisted-pair wire, co-axial cable, fiber optics, or the like.

The platform 602 may establish one or more logical or physical channels to communicate information. The information may include media information and control information. Media information may refer to any data representing content meant for a user. Examples of content may include, for example, data from a voice conversation, videoconference, streaming video, electronic mail (email) message, voice mail message, alphanumeric symbols, graphics, image, video, text, and the like. Data from a voice conversation may be, for example, speech information, silence periods, background noise, comfort noise, tones, and the like. Control information may refer to any data representing commands, instructions or control words meant for an automated system. For example, control information may be used to route media information through a system, or instruct a node to process the media information in a predetermined manner. The embodiments, however, are not limited to the elements or the context shown or described in FIG. 6.

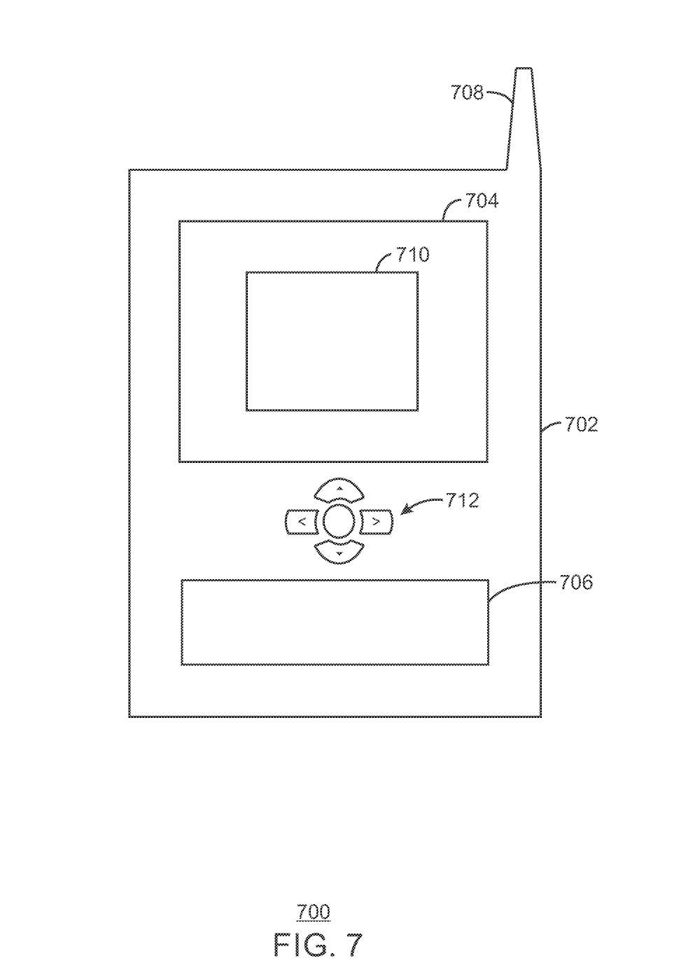

FIG. 7 is a schematic of a small form factor device 700 in which the system 600 of FIG. 6 may be embodied. Like numbered items are as described with respect to FIG. 6. In some embodiments, for example, the device 700 is implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

An example of a mobile computing device may also include a computer that is arranged to be worn by a person, such as a wrist computer, finger computer, ring computer, eyeglass computer, belt-clip computer, arm-band computer, shoe computer, clothing computer, or any other suitable type of wearable computer. For example, the mobile computing device may be implemented as a smart phone capable of executing computer applications, as well as voice communications and/or data communications. Although some embodiments may be described with a mobile computing device implemented as a smart phone by way of example, it may be appreciated that other embodiments can be implemented using other wireless mobile computing devices as well.

As shown in FIG. 7, the device 700 may include a housing 702, a display 704, an input/output (I/O) device 706, and an antenna 708. The device 700 may also include navigation features 710. The display 704 may include any suitable display unit for displaying information appropriate for a mobile computing device. The I/O device 706 may include any suitable I/O device for entering information into a mobile computing device. For example, the I/O device 706 may include an alphanumeric keyboard, a numeric keypad, a touch pad, input keys, buttons, switches, rocker switches, microphones, speakers, a voice recognition device and software, or the like. Information may also be entered into the device 700 by way of microphone. Such information may be digitized by a voice recognition device.

The VCM described herein can be integrated in a number of different applications. In some embodiments, the VCM may be a component of a printing device, such as the printing device 134 of FIG. 1. Additionally, in some embodiments, the VCM may be implemented with a printing device, such as the printing device 134 of FIG. 1. The printing device 136 may include a print object module 138. The printing device can be addressed using the descriptive and protocol components of the VCM. Accordingly, the printing capabilities of the printing device 136 may be defined though the VCM.

Further, in some embodiments, the VCM may be a component of a large display, such as a television. The VCM can be used to define the display capabilities of the television, such as display resolution, dot pitch, response time, brightness, contrast ratio, and aspect ratio. In this manner, images from the VCM may be displayed on the television in a standardized fashion.

### Example 1

An apparatus that enables a hybrid virtual camera module is described herein. The apparatus includes logic to enumerate the image capture components of the apparatus and logic to define a capabilities of the image capture components of the apparatus. The apparatus also includes logic to communicate with the image capture components in a standardized fashion. The logic to enumerate the image capture components of the apparatus can detect an illuminator, an optics component, a digital signal processor. An image capture component of the apparatus may include a monocular multi-view stereoscopic sensor, a stereoscopic camera sensor, a structured light sensor, array camera, plenoptic camera, or any combination thereof. An image capture component of the apparatus may include an illuminator that is used to alter the lighting of the image. Additionally, the logic to communicate with the image capture components in a standardized fashion may produce a composite frame, the composite frame including a depth representation and a texture. The depth representation may be a variable resolution depth map. Additionally, the logic to communicate with the image capture components in a standardized fashion may use a VCM command protocol stream. The VCM command protocol stream can communicate the VCM configurations, methods, and protocols to other components of an apparatus. Additionally, the apparatus may be a printing device or a large display.

### Example 2

An image capture device including a virtual camera module is described herein. The virtual camera module detects a component of the image capture device and communicates with the image capture device using a command protocol stream. A component of the image capture device may be a sensor. The virtual camera module may generate sensor component definitions, and use the sensor component definitions to define the capabilities of the sensor. Additionally, a component of the image capture device may be an illuminator. The virtual camera module may generate illuminator component definitions, and use the illuminator component definitions to define the capabilities of the illuminator.

### Example 3

A computing device with a hybrid virtual camera module is described herein. The computing device includes a central processing unit (CPU) that is configured to execute stored instructions and a storage device that stores instructions. The storage device includes processor executable code that, when executed by the CPU, is configured to enumerate the image capture components of the apparatus and define the capabilities of the image capture components of the apparatus. The code also configures the CPU to vary a depth information of an image from the image capture components, and transmit the depth information in a standardized fashion. The depth information may include a sequence of depth images associated with a composite frame. The composite frame may be defined by a virtual camera module protocol. Each image in the sequence of depth images may have a corresponding timestamp and identification number/attributes. The depth information may include a depth stream header and a depth image protocol associated with a composite frame. Additionally, image capture components of the apparatus may be enumerated using a virtual camera module. Also, the virtual camera module may generate various different image formats. Further, the computing device may be a tablet or a mobile phone.

It is to be understood that specifics in the aforementioned examples may be used anywhere in one or more embodiments. For instance, all optional features of the computing device described above may also be implemented with respect to either of the methods described herein or a computer-readable medium. Furthermore, although flow diagrams and/or state diagrams may have been used herein to describe embodiments, the present techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus that enables a hybrid virtual camera module, the apparatus comprising:
logic to enumerate the image capture components of the apparatus;
logic to define a capabilities of the image capture components of the apparatus; and
logic to communicate with the image capture components in a standardized fashion.

2. The apparatus of claim 1, wherein the logic to enumerate the image capture components of the apparatus detects an illuminator, an optics component, a digital signal processor.

3. The apparatus of claim 1, wherein an image capture component of the apparatus includes a monocular multi-view stereoscopic sensor, a stereoscopic camera sensor, a structured light sensor, array camera, plenoptic camera, or any combination thereof.

4. The apparatus of claim 1, wherein an image capture component of the apparatus includes an illuminator that is used to alter the lighting of the image.

5. The apparatus of claim 1, wherein the logic to communicate with the image capture components in a standardized fashion produces a composite frame, the composite frame including a depth representation and a texture.

6. The apparatus of claim 5, wherein the depth representation is a variable resolution depth map.

7. The apparatus of claim 1, wherein the logic to communicate with the image capture components in a standardized fashion uses a VCM command protocol stream.

8. The apparatus of claim 7, wherein the VCM command protocol stream communicates the VCM configurations, methods, and protocols to other components of an apparatus.

9. The apparatus of claim 1, wherein the apparatus is a printing device.

10. The apparatus of claim 1, wherein the apparatus is a large display.

11. An image capture device including a virtual camera module, where the virtual camera module detects a component of the image capture device and communicates with the image capture device using a command protocol stream.

12. The image capture device of claim 11, wherein a component of the image capture device is a sensor.

13. The image capture device of claim 12, wherein the virtual camera module generates sensor component definitions, and uses the sensor component definitions to define the capabilities of the sensor.

14. The image capture device of claim 11, wherein a component of the image capture device is an illuminator.

15. The image capture device of claim 14, wherein the virtual camera module generates illuminator component definitions, and uses the illuminator component definitions to define the capabilities of the illuminator.

16. A computing device with a hybrid virtual camera module, comprising:
a central processing unit (CPU) that is configured to execute stored instructions;
a storage device that stores instructions, the storage device comprising processor executable code that, when executed by the CPU, is configured to:
enumerate the image capture components of the apparatus;
define the capabilities of the image capture components of the apparatus;
vary a depth information of an image from the image capture components; and
transmit the depth information in a standardized fashion.

17. The computing device of claim 16, wherein the depth information includes a sequence of depth images associated with a composite frame.

18. The computing device of claim 17, wherein the composite frame is defined by a virtual camera module protocol.

19. The computing device of claim 17, wherein each image in the sequence of depth images has a corresponding timestamp and identification number/attributes.

20. The computing device of claim 16, wherein the depth information includes a depth stream header and a depth image protocol associated with a composite frame.

21. The computing device of claim 16, wherein the image capture components of the apparatus are enumerated using a virtual camera module.

22. The computing device of claim 21, wherein the virtual camera module generates various different image formats.

23. The computing device of claim 16, wherein the computing device is a tablet.

24. The computing device of claim 16, wherein the computing device is a mobile phone.
